(19) United States
(12) Patent Application Publication
(10) Pub. No.: US 2017/0173606 A1
(43) Pub. Date: Jun. 22, 2017

(54) DETERMINING PARAMETERS OF AN ELECTROSPRAY SYSTEM

(71) Applicant: STELLENBOSCH UNIVERSITY, Stellenbosch (ZA)

(72) Inventors: Cornelius Louwrens Pieterse, Kenhardt (ZA); Paul Papka, Sanddrift (ZA)

(21) Appl. No.: 15/316,660

(22) PCT Filed: Jun. 5, 2015
(86) PCT No.: PCT/IB2015/054266

§ 371 Date: Dec. 6, 2016

(30) Foreign Application Priority Data
Jun. 6, 2014 (ZA) 2014/04141

(51) Int. Cl. B05B 5/025; B05B 17/04; B64G 1/40; B05B 5/035

(52) U.S. Cl. CPC B05B 5/0255; B05B 5/035; B05B 17/04; B64G 1/405

(57) ABSTRACT

A method of providing a suitable candidate liquid for an electrospray system is provided. At a first step an aperture radius for an aperture of the electrospray system (10) through which the liquid to be electrosprayed is drawn is obtained. Next, a corona threshold electric field curve as a function of relative permittivities of candidate liquids is calculated to determine the electric field at which undesirable corona discharge will occur. The maximum surface tension that can be electrosprayed by the system is calculated and then a candidate liquid which has a chosen relative permittivity and a surface tension that is equal to or less than the maximum surface tension is provided, to thereby provide a suitable candidate liquid with an appropriate surface tension to result in electrospray that meets the requirements of the electrospray system.

### CROSS-REFERENCE TO RELATED APPLICATIONS

This application claims priority to South African provisional patent application number 2014/04141 filed on 6 Jun. 2014, which is incorporated by reference herein.

### FIELD OF THE INVENTION

This invention relates to an electrospray system, and more particularly to a method for determining parameters of an electrospray system.

### BACKGROUND TO THE INVENTION

An electrospray system is an apparatus that employs electricity to produce a fine plume of nanometer- or micrometer-sized droplets through the process called electrohydrodynamic atomisation. Electrospray systems are used in many applications such as the electrospinning of nanofibres, mass spectrometry, the deposition of particles for nanostructures, drug delivery, air purification, advanced printing techniques, and space-based electrostatic propulsion systems, also called colloid thrusters, amongst others.

An electrospray apparatus in its most basic form consists of a chamber for holding a liquid connected to a capillary with a small aperture at its tip that channels the liquid to be sprayed through the aperture. The capillary acts as a first electrode and a second electrode is positioned at an appropriate distance from the capillary. A voltage source applies a voltage to the electrodes. The liquid is emitted by applying a strong electrostatic field to the tip of the capillary by means of a voltage source. In use, the liquid to be sprayed is drawn out of the capillary to form a droplet at the aperture of the capillary and at a particular threshold voltage, the electric field at the tip of the capillary is sufficiently strong such that the surface tension of the liquid is overcome. The slightly rounded tip of the drop of liquid inverts, i.e. forms a Taylor-cone, and emits a jet of liquid. As this jet travels away from the aperture, it eventually becomes unstable and separates into a spray of highly charged droplets. In the case of applications such as propulsion systems, in order to produce propulsion or thrust, the liquid droplets are then accelerated by an electric field.

At high voltages above a certain threshold voltage, corona discharges occur which can damage the electrospray apparatus, destabilise atomisation and/or have other deleterious effects. Corona discharge is an electrical discharge caused by the ionisation of the fluid surrounding a conductor that is electrically energised. While many at least slightly conductive liquids can be used in electrospray systems, a candidate liquid must have a surface tension which is overcome by the applied electric field before the corona discharge electric field is reached. The voltage at which the surface tension is overcome depends on the liquid itself as well as the geometry of the electrospray system. It is generally desirable to have a liquid with a high surface tension, as that liquid will be more likely to atomise into smaller drops and smaller drops lead to higher propellant efficiency and more accurate satellite station keeping operations. However, many apparently suitable liquids with high surface tensions have a corona threshold electric field which is lower than the electric field required to electrospray them for a given geometry, rendering them unsuitable for a particular application.

Current methods of designing electrospray systems for a particular application involve choosing a liquid by testing various liquids for a specific configuration and/or geometry of a system on a trial and error basis. By testing the electrospray capabilities of a range of liquids on the same electrospray apparatus empirically, the liquids that supply the best performance, such as small droplet or particle size for an increased specific impulse, may be identified. This method of identifying an appropriate liquid for an electrospray system may be time-consuming and cumbersome. Once an appropriate liquid has been identified, that liquid may not necessarily be appropriate or optimal for a different electrospray system geometry. The invention seeks to address these problems, at least to some extent.

The preceding discussion of the background to the invention is intended only to facilitate an understanding of the present invention. It should be appreciated that the discussion is not an acknowledgment or admission that any of the material referred to was part of the common general knowledge in the art as at the priority date of the application.

### SUMMARY OF THE INVENTION

In accordance with the invention there is provided a method of providing a suitable candidate liquid for a given electrospray system, comprising the steps of: obtaining an aperture radius for an aperture of the electrospray system through which the liquid to be electrosprayed is drawn; calculating a corona threshold electric field curve in respect of the aperture radius as a function of relative permittivities of candidate liquids so as to determine the electric fields at which undesirable corona discharges will occur; determining a maximum surface tension for the suitable candidate liquid by multiplying the aperture radius by a vacuum permittivity, a relative permittivity of the atmosphere or a relative permittivity of an isolation medium, dividing the result by four and multiplying the further result with the square of a corona threshold electric field obtained from the corona threshold electric field curve; and providing as the suitable candidate liquid, a liquid which has a chosen relative permittivity and has a surface tension which is equal to or less than the maximum surface tension, to thereby provide a suitable candidate liquid with an appropriate surface tension to result in electrospray that meets the requirements of the given electrospray system.

Further features of the invention provide the corona threshold electric field curve to be calculated using a Rousse model, the model being applicable to the hyperbolic point-to-plane geometry of a droplet formed at the aperture of the electrospray system and being defined separately for a radius of curvature of the droplet of more than 100 μm and a radius of curvature of less than 100 μm.

A further feature of the invention provides for the Rousse model to be defined so as to take into account the environmental pressure, humidity and temperature conditions in which the electrospray system will be operated.

Yet a further feature of the invention provides for the corona threshold electric field curve to be obtained by calculating the corona threshold electric field (E_{C}) for a range of relative permittivities of candidate liquids using the equation:

$${E}_{C} = ( \frac{b ɛ + 1}{b ɛ} ) {E}_{O} ,$$

wherein b equals 2 or is a function of the aperture radius, ∈ is the relative permittivity of the candidate liquid and E_{O} is the Rousse threshold electric field given by the equation:

$$\begin{matrix}{E}_{O} = 30 + 9 {R}^{- 0.5} & R \geq 100 μm \\ = 62.7 + 1.74 {R}^{- 0.75} & 15 μm < R < 100 μm\end{matrix}$$

wherein R is a radius of curvature of the droplet in centimetres.

In accordance with a second aspect of the invention there is provided a method of designing an electrospray system for a specific candidate liquid, the method comprising the steps of: selecting a candidate liquid to be electrosprayed and obtaining its surface tension and relative permittivity; calculating an optimum aperture radius by dividing the surface tension of the liquid by a vacuum permittivity, a relative permittivity of the atmosphere or a relative permittivity of an isolation medium, multiplying the result by four and dividing the further result by the square of a corona threshold electric field for the liquid, the corona threshold electric field being obtained by numerical techniques that involve the generation of a two-dimensional surface that depicts a maximum aperture radius at the corona threshold electric field for the surface tension and relative permittivity of the candidate liquid; and providing the electrospray system with an aperture radius which is smaller or equal to the optimum aperture radius.

A further feature of the second aspect of the invention provides for the method to include the step of providing the electrospray system with a separation distance between the aperture and an electrode that is approximately ten times the aperture radius or larger.

A still further feature of the invention provides for a thrust and a specific impulse (Iₛₚ) of the electrospray system to be determined and optimised for the selected candidate liquid and the aperture radius that the system was provided with.

A yet further feature of the invention provides for the thrust (T) and specific impulse (Iₛₚ) to be approximated from the equations:

T˜(2Vρƒ(∈))^{1/2}(KγQ³/∈)^{1/4}

Iₛₚ˜(1/g)(2Vƒ(∈)/ρ)^{1/2}(Kγ/Q∈)^{1/4},

wherein V is the applied voltage, ρ is the fluid mass density, f(∈) is a dimensionless function of the permittivity of the liquid, K is the electric conductivity of the liquid, γ is the surface tension of the liquid, Q is the volumetric flow rate and g is the gravitational constant.

Further features of the invention provides for the minimum volumetric flow rate (Qₘᵢₙ) to be determined empirically and for the electric conductivity (K) of a candidate liquid to be related to the thrust and specific impulse as per the equation:

T˜K^{-1/2} and Iₛₚ˜K^{1/2},

such that the thrust and specific impulse may be optimised for the relative permittivity of the candidate liquid and the aperture radius.

The invention further extends to an electrospraying system comprising a chamber for housing an electrically conductive liquid connected to at least one capillary through which the liquid is drawn in use, the capillary acting as a first electrode or housing a first electrode so as to be in contact with the electrically conductive liquid, at least one aperture which forms an outlet for the capillary, a second electrode positioned away from the aperture, and an electric field source configured to apply an electric field between the first and second electrodes so as to draw out the liquid through the aperture and create an electrospray, characterised in that the aperture radius is selected to be smaller than or equal to an optimum aperture radius which is determined from a surface tension of the liquid divided by a vacuum permittivity, a relative permittivity of the atmosphere or a relative permittivity of an isolation medium, and the result multiplied by four, and the further result divided by the square of a corona threshold electric field for the liquid.

Further features of the invention provide for the electrically conductive liquid to be drawn through the at least one capillary by the potential difference between the electrode and the aperture alone without the need for a pump.

Still a further feature of the invention provides for a pump to be provided as part of the electrospraying system, the pump being in fluid connection with the capillary, so as to provide a larger flow rate of liquid if and when it is required.

A further feature of the invention provides for the electrospraying system to be an electrostatic propulsion system for a spacecraft, also referred to as a colloid thruster. In this embodiment, the electrically conductive liquid is a propellant.

Further features of the invention provide for the electrostatic propulsion system to include an accelerator electrode spaced from the aperture and the second electrode which is arranged to accelerate particles of an electrospray plume to a high velocity prior to being exhausted.

The above and other features of the invention will be more fully understood from the following description and the accompanying drawings.

### BRIEF DESCRIPTION OF THE DRAWINGS

The invention will now be described, by way of example only, with reference to the accompanying drawings in which:

FIG. 1 is a schematic illustration of an experimental setup of an embodiment of the electrospraying system according to the invention;

FIG. 2 is a schematic illustration of a second embodiment of the electrospraying system incorporating a dielectric and nonwetting surface;

FIG. 3 is a graph showing the distribution of the relative permittivity values of more than a thousand liquids;

FIG. 4 is a three-dimensional plot of the corona discharge threshold electric field as a function of the relative permittivity of liquids and the aperture radius of an electrospray system;

FIG. 5 is a three-dimensional plot of the maximum surface tension as a function of the relative permittivity values of liquids and the aperture radius of an electrospray system;

FIG. 6 is a three-dimensional plot of the maximum aperture radius as a function of the surface tension and relative permittivity values of a candidate liquid; and

FIG. 7 is a graph with plots of the maximum aperture radius for the relative permittivity values of 10, 20 and 30 respectively, obtained from the three-dimensional plot of FIG. 6.

### DETAILED DESCRIPTION WITH REFERENCE TO THE DRAWINGS

The electrospray system and techniques described herein find particular application in thruster engines for spacecraft and satellites, but can also be used in many other applications as will be later described.

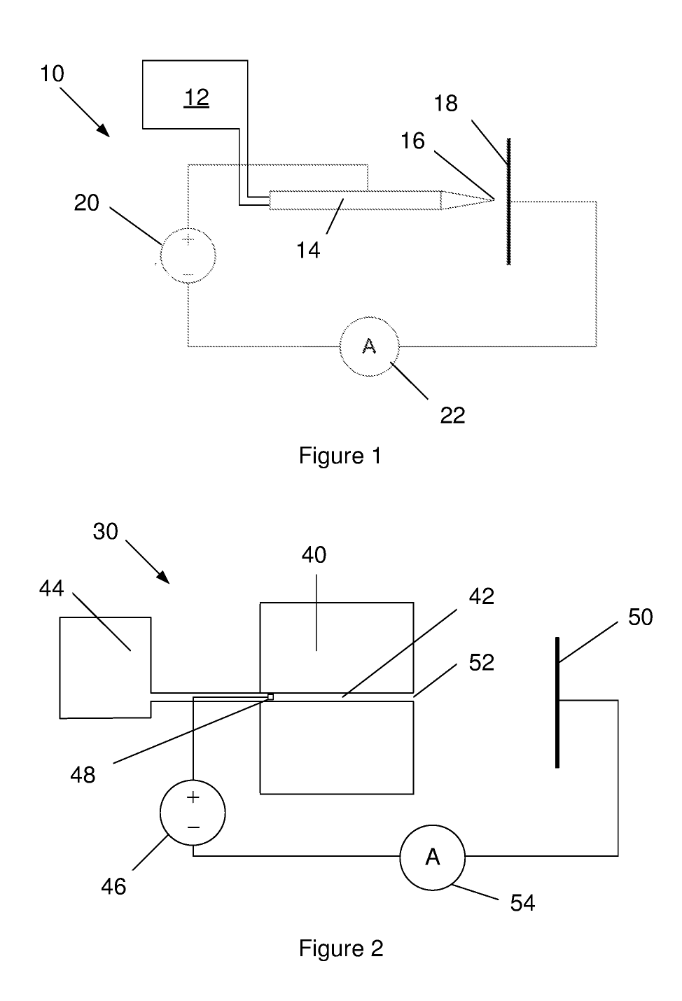

FIG. 1 shows a first embodiment of an electrospray system (10) which includes a chamber (12) for housing an electrically conductive liquid. A capillary (14) is connected to the chamber and terminates in a narrow tip (16) which defines a small aperture that forms an outlet for the capillary. Adjacent this tip, an electrode (18), acting as a counter-electrode to the tip, is positioned and is able to be energised by an electric field source (20) to create a potential difference and electric field between the electrode and the tip to form a Taylor-cone at the aperture. The electrode has any suitable shape and size in accordance with the required electric field characteristics, and it may, for example, be a plate with a planar surface or a ring electrode. The Taylor-cone includes a thin jet of the liquid which moves away from the aperture and separates into a plume of tiny droplets or particles to form an electrospray. In this experimental setup, a current meter (22) is provided in series with the power source as to measure the charged particle flow rate, which is equivalent to the system current. The volumetric flow rate of the liquid and the power consumption of the system can be estimated from the system current.

In this embodiment of the invention, the tip is coated with or made from a conductive material such as gold, platinum, silver, copper or their alloys. The liquid inside the capillary is drawn towards the tip and emitted there through without the need for a pump, owing to the electric potential applied between the tip and the electrode. The capillary may act as either an anode or cathode and the electrode adjacent the tip of the capillary has the opposite polarity to the capillary. Depending on the requirements of the system, a pump may also be included in the system to provide larger liquid flow rates. The tip has a small aperture of a selected radius through which the liquid is emitted. The aperture radius of an electrospray system can be optimised for a candidate liquid that is to be electrosprayed, as will be described later.

For electrostatic propulsion applications or the like, it will be appreciated by someone skilled in the art that the use of more than one capillary emitter connected in parallel will provide enhanced propulsion capabilities. This is possible, provided that the capillary emitters are appropriately spaced apart to not interfere with the electric field at each of the individual apertures. In essence an array of individual capillaries can be used. In such an embodiment, the configuration of the system and electric circuit can be optimised to minimise the power consumption of the system, and/or to maximise the thrust, depending on the requirements for a given application thereof.

FIG. 2 shows a second embodiment of an electrospray system (30) in which at least one capillary (42) is defined within a dielectric, nonwetting flat block (40) with planar outer surfaces. The dielectric, nonwetting flat block (40) has a perforation that has been etched therein to create the capillary (42) which provides an elongate conduit in which liquid flows from a chamber (44) housing the liquid. An electric field source (46) is provided to, in use, apply a potential difference to the conductive liquid by means of an internal electrode (48) located within the elongate cavity of the capillary (42). A second external electrode (50) that is spaced apart from the dielectric, nonwetting flat block (40) at an appropriate separation distance is provided to create a potential difference between the internal and external electrodes. The electrode has any suitable shape and size in accordance with the required electric field characteristics, it may, for example, be a plate with a planar surface or a ring electrode. A current meter (54) is provided in series with the voltage source (46) so as to measure the charged particle flow rate, which is equivalent to the system current. In use, the potential difference results in the formation of a Taylor-cone at the emission site (52) at the open end of the capillary (42). The use of the second embodiment of the invention, may require that the liquids have considerably higher conductivities than the liquids used in the first embodiment of the invention. This is due to the fact that the electrode is located within the capillary requiring the liquid to transmit the applied potential energy from the liquid located at the site of the electrode to the liquid located at the emission site to obtain electrospray.

Depending on the shape, size and weight of the flat block, the surface wetting properties of the flat block can be customised by applying an anti-wetting coating, such as self-assembled monolayers.

The combination of the nonwetting property of the flat block with the sharp corner formed in the surface of the block at the aperture of the capillary anchors the Taylor-cone structure from which emission occurs. The dielectric constant of the block of material needs to be low such that the droplet of liquid that forms at the aperture experiences an electric field in a similar way to that of a droplet that forms at the end of a sharp, conductive capillary tip. The droplet on the surface of the dielectric, nonwetting flat block has the same hyperbolic point-to-plane geometry as that of a droplet at the end of a needle tip and therefore the same methods of determining the onset voltage for corona discharge applies to this second embodiment of an electrospray system. In this embodiment the aperture radius will refer to the radius of the opening at the emission site in the flat block. The aperture radius is approximately equivalent to the radius of curvature of a droplet of liquid that forms at the aperture during use of the electrospray system.

It is envisaged that the second embodiment of the invention can be manufactured more easily by microfabrication techniques developed for the electronics and microelectromechanical systems (MEMS) industries in comparison to the more labour intensive manufacturing of capillaries of specific aperture radii. Microfabrication is a more simple manufacturing technique for producing arrays of a large number of individual emitters for electrosprays that may find application as space propulsion thrusters or for electrosprays that may find application in analytical techniques that require an array of emitters. In particular, an array used for space propulsion allow for thrust vector control of a spacecraft by manipulation of the direction of thrust from the individual emitters. In this manner the attitude or angular velocity of the spacecraft may be controlled.

The chosen aperture radius at the end of a needle tip or the aperture radius of a perforation in a dielectric, nonwetting flat block will, in part, determine the voltage that is required to overcome the surface tension of a particular droplet of the liquid at the aperture so as to form an electrospray. Electrospray results in a net ion current (I) in an electrospray system as the charged droplets migrate towards the second electrode, i.e. the counter-electrode. The net ion current can be calculated from equation 1:

$$I = \frac{f ( ɛ )}{\sqrt{ɛ}} \sqrt{γ KQ} , \qquad ( 1 )$$

wherein ∈ is the relative permittivity of the liquid, K is the electrical conductivity of the liquid, Q is the volumetric flow rate and wherein the empirical function f(∈)=∈/2 is defined for ∈<40 and f(∈)=20 for ∈≧40 respectively. The electric field at the aperture (E_{π}) is given by the Mason equation, equation 2:

$${E}_{τ} = \frac{2 V}{R ln ( \frac{4 L}{R} )} , \qquad ( 2 )$$

wherein, V is the applied voltage, R is the aperture radius, and L is the distance between the aperture and the counter-electrode. The above equation does not take into account the effect of space charge, which would result in a reduced electric field at the aperture and is only valid for R>>L [symbol] 10R≦L.

The critical voltage (V_{crit}) and electric field (E_{crit}) applied to the tip and the electrode, initiating the liquid surface instability and therefore leading to electrospraying are given by the equations 3a and 3b respectively:

$$\begin{matrix}{V}_{crit} = \sqrt{\frac{γ R}{{ɛ}_{0}}} ln ( \frac{4 L}{R} ) & ( 3 a ) \\ {E}_{crit} = 2 \sqrt{\frac{γ}{{ɛ}_{0} R}} , & ( 3 b )\end{matrix}$$

wherein γ is the liquid surface tension and ∈₀ is the vacuum permittivity.

Generally, the smaller the aperture radius, the higher the surface tension of a candidate liquid may be to obtain electrospray at a given electric field before the onset of corona discharges.

It is important that a voltage is selected which reduces the likelihood of undesirable corona discharge from occurring, making it possible for the system to be used in atmospheric or other conditions using liquids having a relatively high surface tension, such as liquids with surface tensions in excess of 50 mN/m. Use of a lower voltage to obtain electrospray also results in much lower overall power consumption.

Taking into account the above considerations and in accordance with the invention, methods are provided that allow for the implementation of the optimum parameters in an electrospray system to obtain a desired electrospray particle size and/or produce the required amount of thrust.

In accordance with the first aspect of the invention, a method for providing a suitable candidate liquid for a given electrospray system is provided. Firstly, the electrospray system is provided with a selected aperture radius for an aperture of the electrospray system through which the liquid to be electrosprayed is drawn. Subsequently, a corona threshold electric field curve, as a function of the liquid relative permittivity, is calculated so as to determine the electric field at which undesirable corona discharge will occur in respect of different liquid relative permittivities. Thereafter, the maximum surface tension for the candidate liquid is determined by multiplying the aperture radius by a vacuum permittivity constant, a relative permittivity of the atmosphere or the relative permittivity of an isolation medium, depending on which is applicable, dividing it by four and multiplying it with the square of the corona threshold electric field. The final step involves providing the system with a given candidate liquid, which has approximately the chosen relative permittivity and has a surface tension which is equal to or less than the determined maximum surface tension, to thereby provide a suitable candidate liquid with an appropriate surface tension as per the application requirements.

The above described method is based on the theory that a candidate liquid can be selected for an electrospray system when the geometrical parameters of said system is known and fixed. In such a case the corona threshold electric field (E_{c}) can be calculated from equation 4:

$${E}_{C} = ( \frac{2 ɛ + 1}{2 ɛ} ) {E}_{O} , from \\ {E}_{C} = {E}_{O} - {E}_{P} + χ ( p , φ , T ) = ( \frac{b ɛ + 1}{b ɛ} ) {E}_{O} , \qquad ( 4 )$$

wherein E_{O} is the corona onset field of the Rousse model (Rousse threshold electric field), E_{P} is the polarization field at the capillary tip calculated with the function b(R)=p1·R+p2, wherein p1=11229 m⁻¹ and p2=0.1092, ∈ is the relative permittivity of the candidate liquid. An approximation of the b(R) function is often used in the art in which b=2. The function χ accounts for empirical experimental factors (such as pressure p, humidity φ and temperature T). In this manner the model can be defined so as to take into account the pressure, humidity and temperature conditions in which the electrospray system will be operated.

The polarization fields of electrospraying geometries can be calculated from equation 5:

$${E}_{P} = \frac{- {E}_{τ}}{2 ɛ + 1} = \frac{- 2 V}{( 2 ɛ + 1 ) R ln ( 4 L \text{/} R )} . \qquad ( 5 )$$

Cloupeau proposed an approximation method, to calculate the corona onset fields for such geometries. This adapted version was first postulated by Rousse. The Rousse threshold electric field is given by equation 6:

$$\begin{matrix}{E}_{O} = 30 + 9 {R}^{- 0.5} & R \geq 100 μm \\ = 62.7 + 1.74 {R}^{- 0.75} & 15 μm < R < 100 μm ,\end{matrix} \qquad ( 6 )$$

with results of the form kV/cm. Cloupeau verified that these equations hold for the above and radii as small as 2.5 μm. The above Rousse model is permittivity independent, and therefore does not account for polarization effects. A model that is similar to the Rousse model is used to calculate the corona discharge onset (E_{C}) for the current invention in terms of the specific geometry of the aperture of the tip and the relative permittivity of most liquids.

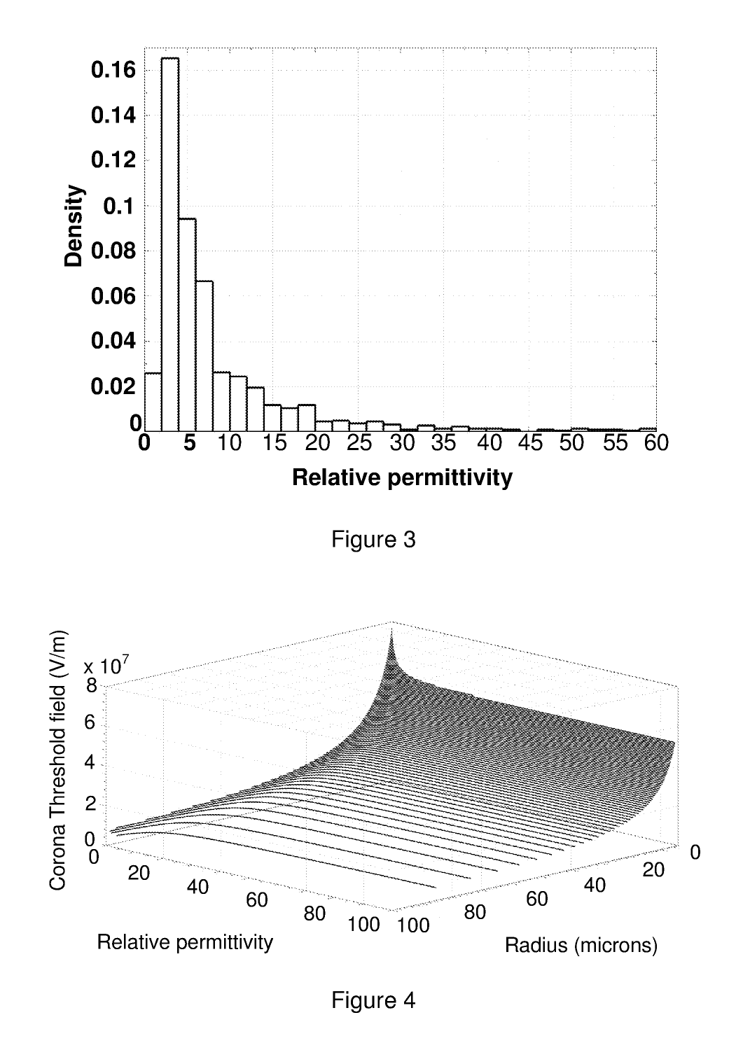

A survey of the relative permittivity of more than a thousand liquids shown as a distribution plot in FIG. 3, shows that a relative permittivity of 5 may be chosen to represent the majority of candidate liquids. Relative permittivity values of between 0 and 20 are most commonly associated with liquids according to the survey.

Using the Rousse threshold electric field one can determine, for a given liquid, the electric field at which undesirable corona discharge will occur for a selected candidate liquid. FIG. 4 is a three-dimensional plot displaying a surface of the corona discharge threshold as it varies with the relative permittivity of candidate liquids and the aperture radius of the electrospray system as determined by equation 4.

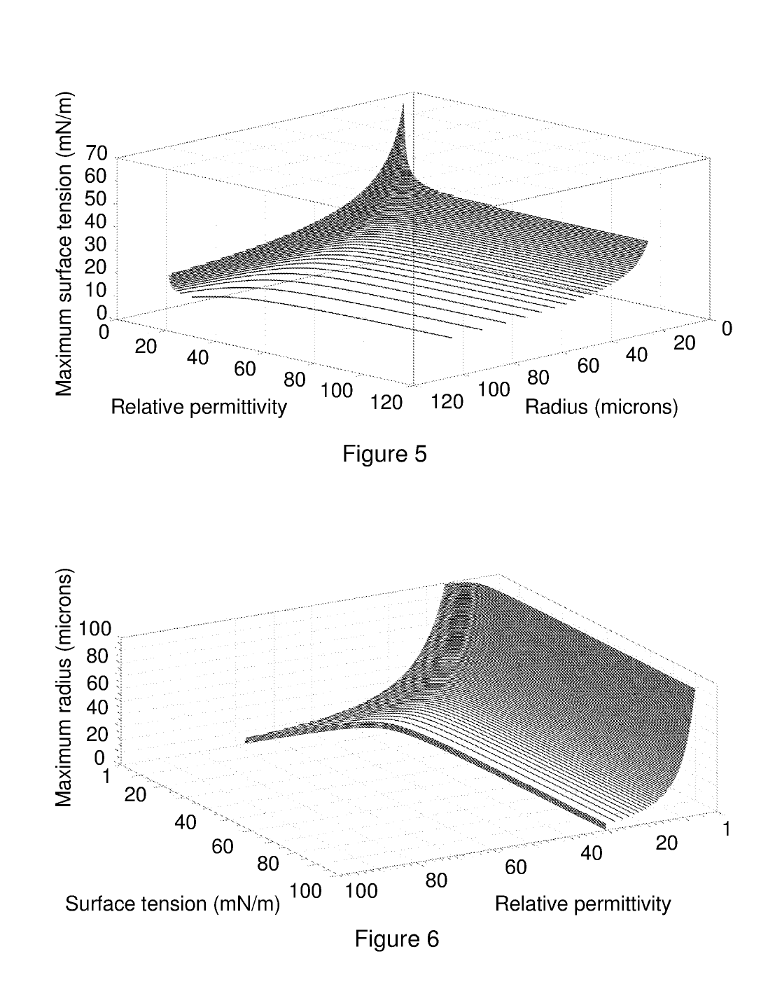

Since the corona threshold electric field and the radius of the aperture of the electrospray system is known, the maximum surface tension (γ_{c}) of a liquid to be electrosprayed can be determined analytically, using equation 7:

$${γ}_{C} = \frac{R {ɛ}_{0}}{4} {E}_{C}^{2} , suggesting {γ}_{C} \text{∼} {R}^{- 0.5} , \qquad ( 7 )$$

where R is the aperture radius, ∈₀ is the vacuum permittivity, the relative permittivity of the atmosphere or the relative permittivity of an isolation medium, whichever is applicable, and E_{c} is the corona threshold electric field. FIG. 5 is a three-dimensional plot displaying a surface of the maximum surface tension as a function of the relative permittivity of candidate liquids and the aperture radius. From FIG. 5 and equation 7 it is evident that the maximum surface tension that can be electrosprayed before corona discharge occurs is inversely proportional to the aperture radius of the capillary.

It should be noted that for the given approach, the electrode separation distance, which is the distance between the radius aperture and the electrode that is spaced therefrom, is not fixed. The electrode separation distance determines the corona onset voltage (V_{c}) from the Mason equation, rewritten as equation 8:

$${E}_{τ} = \frac{2 V}{R ln ( 4 L \text{/} R )} ⇒ {V}_{C} = \frac{{E}_{C} R ln ( 4 L \text{/} R )}{2} , \qquad ( 8 )$$

wherein E_{τ} is the electric field experienced at the aperture of the capillary, E_{c} is the corona threshold electric field, R is the aperture radius and L is the separation distance. A separation distance-radius ratio of approximately 10:1 will result in the highest corona onset fields, enabling the electrospray of higher surface tension liquids without corona discharges occurring. It is possible to use a separation distance-radius ratio of less than 10:1, but then a correction factor must be introduced in the model. The electrospraying voltage (V_{crit}) and corona onset voltage (V_{c}) will determine the applied voltage (V_{applied}) operation range of the system as demonstrated by means of equation 9:

V_{crit}≦V_{applied}<V_{C} (9)

In accordance with a second aspect of the invention, a method of designing an electrospray system for a specific candidate liquid is provided. The first step of the method is selecting a candidate liquid to be electrosprayed and obtaining its surface tension and relative permittivity. The second step is to calculate an optimum aperture radius by dividing the surface tension of the liquid by a vacuum permittivity, the relative permittivity of the atmosphere or the relative permittivity of an isolation medium, multiplying it by four and dividing it by the square of a corona threshold electric field for the liquid. In this case, as the radius of curvature of the droplet of liquid at the aperture is unknown, the corona threshold electric field must be obtained by numerical techniques that involve the generation of a two-dimensional surface that depicts a maximum aperture radius at the corona threshold electric field for the surface tension and relative permittivity of the candidate liquid. The final step involves providing the electrospray system with an aperture radius which is smaller or equal to the optimum aperture radius. In the case of further properties of the liquid being known it may not be necessary to obtain the maximum aperture radius from a two-dimensional surface as described above, but a single value for the maximum radius can be obtained by substitution of the relevant values into equations 4, 6 and 7.

This method is derived from the theory that when the surface tension and relative permittivity of a selected liquid are known, it is possible to determine the maximum aperture radius for an electrospray system. The electrospray system can, therefore, be designed specifically for use with the selected liquid. Equations 4, 6 and 7 are not analytically solvable for the aperture radius as the radius of curvature of the liquid droplet at the aperture is unknown and thus the corona threshold electric field cannot be determined directly.

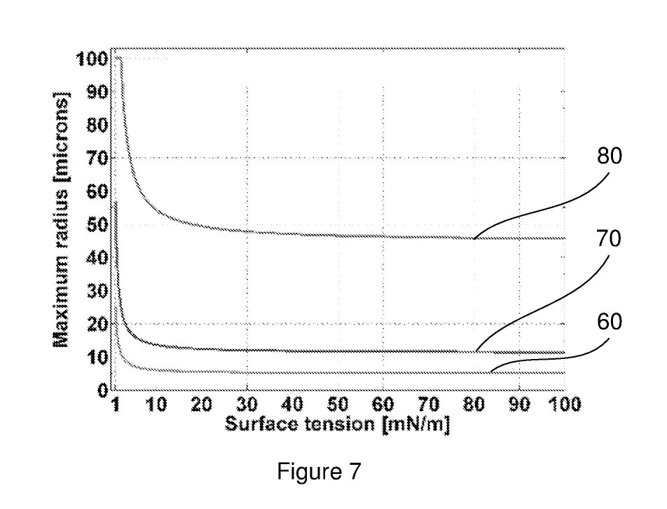

These equations can, however, be solved by making use of numerical techniques. Equation 6 was solved numerically for radii of curvature that are smaller than 100 μm, and subsequently, equations 4 and 7 were also solved numerically. The same numerical techniques can be used to solve the equations for radii of curvature larger than or equal to 100 μm. It has already been proven that the corona discharge threshold is higher for a smaller aperture radius, which would suggest that for a higher surface tension, the maximum radius of the aperture would decrease. The result of the numerical solution of equation 7 is shown in FIG. 6. FIG. 6 is a three-dimensional plot showing a surface of the maximum aperture radius as a function of the surface tension and relative permittivity values. It can be noted that for a relative permittivity of approximately 10, there is a plateau of surface tension values for which the maximum radius is the same. This is due to the fact that the numerical solution was limited to R≦100 μm. FIG. 7 shows three plots, which are slices from FIG. 6, of the maximum aperture radius for relative permittivity values of 10 (plot labelled 80), 20 (plot labelled 70) and 30 (plot labelled 60).

FIG. 6 depicting the maximum aperture radius as the function of two different properties of a candidate liquid, can be used as a guideline for the design of an electrospray system. Once the surface tension and relative permittivity of a candidate liquid is known, the maximum aperture radius can be read from FIG. 6 and the electrospray system can be provided with the optimum aperture radius. It will be appreciated that it is advisable to then use a smaller radius than the maximum aperture radius to reduce the corona electric threshold field.

If further properties of a candidate liquid for which the electrospray system has been designed are known and in the case of the electrospray system being used as an electrostatic propulsion system, the thrust (T) and specific impulse (Iₛₚ) can be approximated using equations 10 and 11:

$$\begin{matrix}T \text{∼} {( 2 V ρ f ( ɛ ) )}^{\frac{1}{2}} {( \frac{K γ {Q}^{3}}{ɛ} )}^{\frac{1}{4}} & ( 10 ) \\ {l}_{sp} \text{∼} ( \frac{1}{g} ) {( \frac{2 V f ( ɛ )}{ρ} )}^{\frac{1}{2}} {( \frac{K γ}{Q ɛ} )}^{\frac{1}{4}} , & ( 11 )\end{matrix}$$

where V is the applied voltage, ρ is the fluid mass density, f(∈) is a dimensionless function of the relative permittivity of the liquid, K is the electric conductivity of the liquid, γ is the surface tension of the liquid, Q is the volumetric flow rate and g is the gravitational constant.

Given that the minimum volumetric flow rate (Qₘᵢₙ) can be determined empirically using equation 12:

$$\frac{ρ {Q}_{min} K}{{γɛ}_{0} ε} \text{∼} 1 {Q}_{min} = \frac{{γɛ}_{0} ɛ}{ρ K} , \qquad ( 12 )$$

Equations 10 and 11 can be optimised for the thrust and the specific impulse to obtain the relations: T˜K^{-1/2} and Iₛₚ˜K^{1/2}. The design of the electrospray system in terms of the voltage that is applied and the aperture radius can therefore be further optimised to obtain a desired thrust and specific impulse.

For applications in which the electrospraying system of the invention is used in space, an accelerator electrode may also be provided, spaced from the tip, and arranged to accelerate the electrospray to a high velocity prior to being exhausted. As will be appreciated by a person skilled in the art, in the combined application of two electrospray systems as part of a colloid thruster, in which a first thruster that produces a spray of only positive or negative ions is accompanied by a second thruster that produces an electrostatic spray of ions of an opposite charge to that of the first thruster, both aperture radii of the two individual thrusters will be selected according to the properties of the two different liquids used. The positive and negative ions neutralise each other such that the spacecraft remains approximately electrically neutral without the need for a separate electron, positron or other type of neutralising source.

In accordance with the method of selecting a candidate liquid for an electrospray system, a number of candidate liquids can be identified which may be used as suitable liquid propellants in an electrostatic propulsion system. As can be envisaged, further characteristics of the liquid for use as a propellant may be important. Thus, in addition to the selection of a propellant based on surface tension and relative permittivity, propellants may be selected for their ability to produce anions and cations of high mass, leading to higher thrust and greater efficiencies, their price, ability to dissolve, ion size, high liquid density, vapour pressure, conductivity and so forth.

An electrospray system and the methods herein described find particular application for electrostatic propulsion in space, but may be applied in many other applications. For example, the production of very fine powder used in the cosmetic and pharmaceutical industries is one of the applications of electrospray. The techniques of the invention could also be applied to medical nebulizers, where smaller particle sizes leads to greater absorption of the active ingredient by the body. Medical nebulizers can be specifically designed for liquids or liquid mixtures if the properties of these liquids or liquid mixtures are known.

Other applications for electrospray include the electrospinning of nanofibres, the production of fine metal powders for components in paste for thin conducting films in electronic devices, the production of photonic crystals and fibres, air purification, advanced printing techniques, the deposition of particles for nanostructures, mass spectrometry and other analytical techniques and the like. The electrospray systems with the abovementioned varied uses and the different liquids associated therewith, may all be optimised using the methods described herein.

Throughout the specification and claims unless the contents requires otherwise the word ‘comprise’ or variations such as ‘comprises’ or ‘comprising’ will be understood to imply the inclusion of a stated integer or group of integers but not the exclusion of any other integer or group of integers.

1. A method of providing a suitable candidate liquid for a given electrospray system, comprising the steps of: obtaining an aperture radius for an aperture of the electrospray system through which the liquid to be electrosprayed is drawn; calculating a corona threshold electric field curve in respect of the aperture radius as a function of relative permittivities of candidate liquids so as to determine the electric fields at which undesirable corona discharges will occur; determining a maximum surface tension for the candidate liquid by multiplying the aperture radius by a vacuum permittivity, a relative permittivity of the atmosphere or a relative permittivity of an isolation medium, dividing the result by four and multiplying the further result with the square of a corona threshold electric field obtained from the corona threshold electric field curve; and providing as the suitable candidate liquid, a liquid which has a chosen relative permittivity and has a surface tension which is equal to or less than the maximum surface tension, to thereby provide a suitable candidate liquid with an appropriate surface tension to result in electrospray that meets the requirements of the given electrospray system.

2. The method as claimed in claim 1, wherein the corona threshold electric field curve is calculated using a Rousse model, the model being applicable to a hyperbolic point-to-plane geometry of a droplet formed at the aperture of the electrospray system and being defined separately for a radius of curvature of the droplet of more than 100 μm and a radius of curvature of less than 100 μm.

3. The method as claimed in claim 2, wherein the Rousse model is defined so as to take into account the environmental pressure, humidity and temperature conditions in which the electrospray system will be operated.

4. The method as claimed in claim 1, wherein the corona threshold electric field curve is obtained by calculating the corona threshold electric field (E_{C}) for a range of relative permittivities of candidate liquids using the equation:
$${E}_{C} = ( \frac{b ɛ + 1}{b ɛ} ) {E}_{O} ,$$
wherein b equals 2 or is a function of the aperture radius, E is the relative permittivity of the candidate liquid and E_{O} is the Rousse threshold electric field given by the equation:
$$\begin{matrix}{E}_{O} = 30 + 9 {R}^{- 0.5} & R \geq 100 μm \\ = 62.7 + 1.74 {R}^{- 0.75} & 15 μm < R < 100 μ m\end{matrix}$$
wherein R is a radius of curvature of the droplet in centimeters.

5. A method of designing an electrospray system for a specific candidate liquid, the method comprising the steps of: selecting a candidate liquid to be electrosprayed and obtaining its surface tension and relative permittivity; calculating an optimum aperture radius by dividing the surface tension of the liquid by a vacuum permittivity, a relative permittivity of the atmosphere or a relative permittivity of an isolation medium, multiplying the result by four and dividing the further result by the square of a corona threshold electric field for the liquid, the corona threshold electric field being obtained by numerical techniques that involve the generation of a two-dimensional surface that depicts a maximum aperture radius at the corona threshold electric field for the surface tension and relative permittivity of the candidate liquid; and providing the electrospray system with an aperture radius which is smaller or equal to the optimum aperture radius.

6. The method as claimed in claim 5, wherein the method includes the step of providing the electrospray system with a separation distance between an aperture and an electrode that is approximately ten times the aperture radius or larger.

7. The method as claimed in claim 5, wherein a thrust and a specific impulse of the electrospray system are determined and optimized for the selected candidate liquid and the aperture radius that the system was provided with.

8. The method as claimed in claim 7, wherein the thrust (T) and specific impulse (Iₛₚ) is approximated from the equations:
T˜(2Vρƒ(∈))^{1/2}(KγQ³/∈)^{1/4}
Iₛₚ˜(1/g)(2Vƒ(∈)/ρ)^{1/2}(Kγ/Q∈)^{1/4},
wherein V is the applied voltage, p is the fluid mass density, f(∈) is a dimensionless function of the permittivity of the specific candidate liquid, K is the electric conductivity of the liquid, γ is the surface tension of the liquid, Q is the volumetric flow rate and g is the gravitational constant.

9. The method as claimed in claim 8, wherein a minimum volumetric flow rate (Qₘᵢₙ) is determined empirically and the electric conductivity (K) of a candidate liquid is related to the thrust (T) and specific impulse (Iₛₚ) as per the equation:
T˜K^{-1/2} and Iₛₚ˜K^{1/2},
such that the thrust and specific impulse may be optimized for the relative permittivity of the candidate liquid and the aperture radius.

10. An electrospraying system comprising a chamber housing a selected electrically conductive liquid connected to at least one capillary through which the liquid is drawn in use, the capillary acting as a first electrode or housing a first electrode so as to be in contact with the electrically conductive liquid, at least one aperture which forms an outlet for the capillary, a second electrode positioned away from the aperture, and an electric field source configured to apply an electric field between the first and second electrodes so as to draw out the liquid through the aperture and create an electrospray, wherein the aperture radius is selected to be substantially equal to an optimum aperture radius, the optimum aperture radius being equal to: a surface tension of the selected liquid divided by a vacuum permittivity, a relative permittivity of the atmosphere or a relative permittivity of an isolation medium, the result multiplied by four, and the further result divided by the square of a corona threshold electric field for the liquid.

11. The electrospraying system as claimed in claim 10, wherein the electrically conductive liquid is drawn through the at least one capillary by the electric field between the first and second electrodes.

12. The electrospraying system as claimed in claim 10, wherein a pump is provided as part of the electrospraying system, the pump being in fluid connection with the capillary, so as to provide a larger flow rate of liquid if and when it is required.

13. The electrospraying system as claimed in claim 10, wherein the electrospraying system is an electrostatic propulsion system for a spacecraft and the electrically conductive liquid is a propellant.

14. The electrospraying system as claimed in claim 13, wherein the electrostatic propulsion system includes an accelerator electrode spaced from the aperture and the second electrode which is arranged to accelerate particles of an electrospray plume to a high velocity prior to being exhausted.
